(19) United States
(12) Patent Application Publication
(10) Pub. No.: US 2019/0129344 A1
(43) Pub. Date: May 2, 2019

(54) IMAGE FORMING APPARATUS AND IMAGE FORMING SYSTEM

(71) Applicant: TOSHIBA TEC KABUSHIKI KAISHA, Tokyo (JP)

(72) Inventor: Koichiro SATO, Sunto Shizuoka (JP)

(21) Appl. No.: 16/030,190

(22) Filed: Jul. 9, 2018

(30) Foreign Application Priority Data
Oct. 26, 2017 (JP) 2017-207112

(51) Int. Cl. G03G 15/00; G03G 21/00

(52) U.S. Cl. CPC G03G 15/6529; G03G 21/0064

(57) ABSTRACT

An image forming apparatus includes a sheet feeding unit configured to hold a plurality of sheets, an image forming unit configured to form a toner image on a sheet, and a carrying unit configured to sequentially carry sheets from the sheet feeding unit in a carrying direction towards the image forming unit. A mechanical cleaner is provided to remove extraneous matter from a portion of the image forming unit. A moving mechanism is configured to re-position the sheet along a sheet width direction intersecting the sheet carrying direction. The moving mechanism is on an upstream side of a position along the carrying direction at which the toner image is formed on the sheets.

### CROSS-REFERENCE TO RELATED APPLICATION

This application is based upon and claims the benefit of priority from Japanese Patent Application No. 2017-207112, filed Oct. 26, 2017, the entire contents of which are incorporated herein by reference.

### FIELD

An embodiment described herein relates generally to an image forming apparatus and an image forming system.

### BACKGROUND

An image forming apparatus may form an image on a sheet. The sheet may be a label sheet in some instances. The label sheet comprises a base material and release paper. The base material and release paper are affixed to each other with an adhesive.

In the image forming apparatus, when an image is formed on a label sheet, a small amount of the adhesive might protrude from an edge of the label sheet and thus may adhere to a transfer belt of the image forming apparatus. It is difficult to remove any adhesive adhering to the transfer belt with a standard cleaning blade. Furthermore, if adhesive is thickly deposited on the transfer belt, there is a possibility that the cleaning blade will not come into full contact with the transfer belt. When this occurs, part of the image forming toner might remain on the transfer belt after a cleaning attempt. Such residual toner will then adhere to the next (or a subsequent) sheet in the secondary transfer unit, which may cause poor image formation.

### DESCRIPTION OF THE DRAWINGS

FIG. 1 depicts an image forming apparatus according to an embodiment.

FIG. 2A is a plan view of a paper feeding unit.

FIG. 2B is a side sectional view of a paper feeding unit.

FIG. 3 depicts a moving mechanism.

FIG. 4 is a schematic view of an example of a label sheet.

FIG. 5A is a plan view of a paper feeding unit.

FIG. 5B is a side sectional view of a paper feeding unit.

FIG. 6A is a plan view of a paper feeding unit.

FIG. 6B is a side sectional view of a paper feeding unit.

FIG. 7A is a plan view of a paper feeding unit.

FIG. 7B is a side sectional view of a paper feeding unit.

FIG. 8 is a schematic view showing arrangements of sheets.

FIG. 9 is a schematic view showing an exposure start point on a photoconductive drum.

FIG. 10 is a schematic view showing an example of a control panel.

FIG. 11 is a flowchart of processing by a control unit.

FIG. 12 depicts a part of the image forming apparatus of FIG. 1.

FIG. 13 depicts a part of the image forming apparatus of FIG. 1.

FIG. 14 depicts an image forming system of an embodiment.

FIG. 15 depicts a displacement mechanism.

### DETAILED DESCRIPTION

In general, according to one embodiment, an image forming apparatus includes a sheet feeding unit configured to hold a plurality of sheets, an image forming unit configured to form a toner image on a sheet, and a carrying unit configured to sequentially carry sheets from the sheet feeding unit in a carrying direction towards the image forming unit. A mechanical cleaner is provided to remove extraneous matter (such as, residual toner and/or adhesive from printable labels fed through the image forming apparatus) from a portion of the image forming unit. A moving mechanism is configured to re-position each of the sheets along a width direction intersecting the carrying direction. The moving mechanism is located on an upstream side from a position along the carrying direction at which the toner image is formed on the sheet.

Hereinafter, an image forming apparatus and an image forming system of example embodiments will be described with reference to drawings.

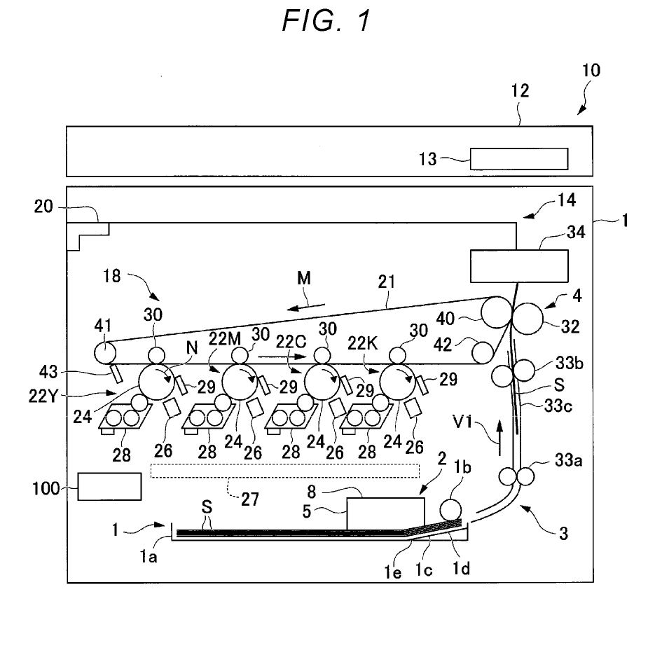

FIG. 1 is a configuration diagram of an image forming apparatus 10 according to an embodiment. As an example of the image forming apparatus 10, a multi-function peripheral (“MFP”) will be described. In this context, image forming apparatus 10 may thus be referred to as MFP 10.

As shown in FIG. 1, the MFP 10 includes a scanner 12, a control panel 13, and a main body 14. The scanner 12 reads an original document. The control panel 13 includes input keys and a display unit. For example, the input key receives an input from a user. The scanner 12, the control panel 13, and the main body 14 may each be controlled by a control unit. The MFP 10 includes a system control unit 100, which is a control unit which controls overall operations of each sub-system of the MFP 10.

The main body 14 includes a paper feeding unit 1, a moving mechanism 2, a carrying unit 3, a printer unit 18, and the like.

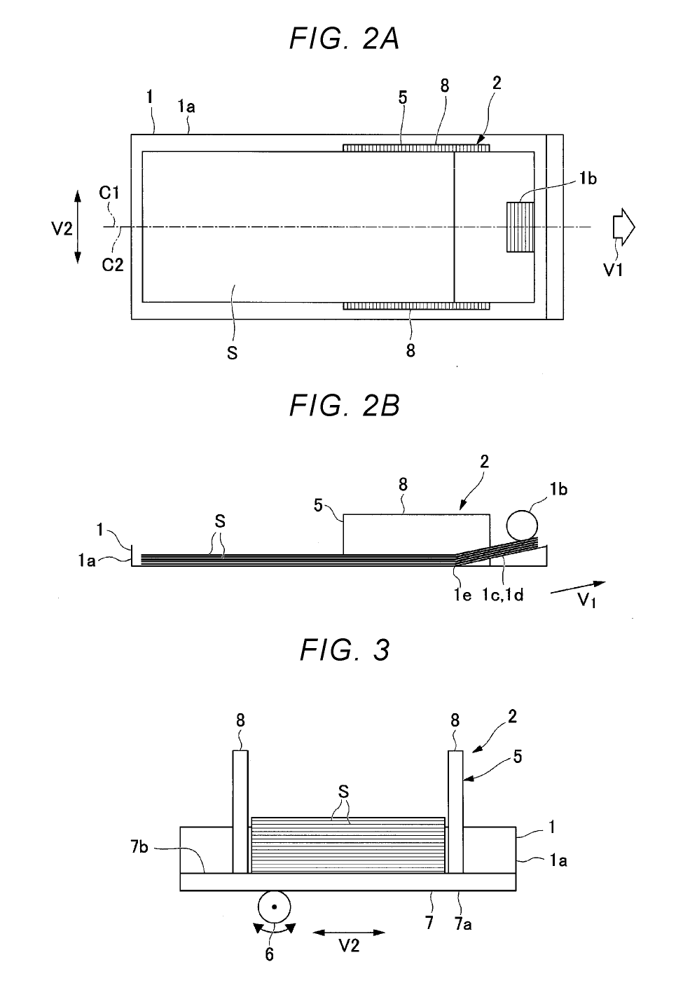

FIG. 2A is a plan view of the paper feeding unit 1. FIG. 2B is a side sectional view of the paper feeding unit 1. As shown in FIGS. 2A and 2B, the paper feeding unit 1 includes a sheet feeding cassette 1a, a pickup roller 1b, and a height adjusting mechanism 1c. In the following description, the carrying direction V1 is the conveyance direction of a sheet S. The width direction V2 is a direction parallel to a surface of the sheet S and orthogonal to the carrying direction V1.

The sheet feeding cassette 1a accommodates a plurality of sheets S. The sheet S may be a label sheet. The pickup roller 1comes into contact with the uppermost sheet S in the sheet feeding cassette 1a and sends out the sheet S from the sheet feeding cassette la to the carrying unit 3.

The height adjusting mechanism 1c includes a lifting plate 1d and a lifting and lowering mechanism (not shown). The lifting plate 1d is provided at the bottom of the sheet feeding cassette 1a. The lifting plate 1d supports the leading end (in the carrying direction V1) of the sheet S. The lifting plate 1d includes a hinge 1e along the width direction V2. The lifting plate 1d may switch between a paper feeding position and a retracted position by rotation about the hinge 1e. The paper feed position is shown in FIG. 2B and is a position at which the uppermost sheet S is lifted until in contact with the pickup roller 1b. In the retracted position (see FIG. 5B) the uppermost sheet S is separated from the pickup roller 1b. The lifting and lowering mechanism rotates the lifting plate 1d by a driving source (such as a motor).

As shown in FIG. 1, the carrying unit 3 includes a carrying roller 33a, an alignment roller 33b, and a carrying guide 33c. The carrying roller 33a receives the sheet S sent by the pickup roller 1b. The alignment roller 33b receives the sheet S after passed by the carrying roller 33a and carries the sheet S toward the transfer unit 4.

FIG. 3 is a configuration diagram of the moving mechanism 2. As shown in FIG. 3, the moving mechanism 2 includes a positioning member 5, a driving gear 6, and a driving source (a motor or the like) (not shown). The positioning member 5 includes a base 7 and a pair of regulating plates 8. The base 7 has an elongated plate shape extending in the width direction V2. Teeth for meshing with teeth of the driving gear 6 are formed on a lower edge 7a of the base 7 in a longitudinal direction.

The regulating plates 8 protrude upward on an upper edge 7b of the base 7. The regulating plates 8 protrude upward from the bottom surface of the sheet feeding cassette 1a. The regulating plate 8 is perpendicular to the bottom surface of the sheet feeding cassette 1a and extends along the carrying direction V1 (see FIG. 2A). The pair of regulating plates 8 are separated from each other in the width direction V2. The pair of regulating plates 8 are positioned on both sides of the sheet S and restrict the sheet S from moving in the width direction V2. The regulating plate 8 determines the position of the sheet S in the width direction V2.

The driving gear 6 transmits the driving force of the driving source to the positioning member 5. The driving gear 6 moves the positioning member 5 in the width direction V2. The driving gear 6 determines the position of the positioning member 5. The moving mechanism 2 adjusts the position in the width direction V2 of the sheet S held by the paper feeding unit 1.

The printer unit 18 forms an image on a sheet S. For example, the printer unit 18 performs image formation based on information of read from an original document image by the scanner 12. The printer unit 18 includes an intermediate transfer belt 21. The printer unit 18 supports the intermediate transfer belt 21 with a backup roller 40, a driven roller 41, and a tension roller 42. The backup roller 40 includes a driving unit (not specifically depicted). The intermediate transfer belt 21 travels in the direction of the arrow M.

The printer unit 18 includes four image forming units 22Y, 22M, 22C, and 22K. The image forming units 22Y, 22M, 22C, and 22K are used for image formation of Y (yellow), M (magenta), C (cyan), and K (black), respectively. The image forming units 22Y, 22M, 22C, and 22K are disposed along the traveling direction of the intermediate transfer belt 21.

The image forming unit 22Y will be described as an example. The image forming units 22M, 22C, and 22K have substantially the same configuration as that of the image forming unit 22Y, so a detailed description of these other units is omitted.

The image forming station 22Y includes a photoconductive drum 24, an electrostatic charger 26, an exposure scanning head 27, a developing device 28, and a primary transfer roller 30. The electrostatic charger 26, the exposure scanning head 27, and the developing device 28 are disposed at various positions along a rotation direction of the photoconductive drum 24. The photoconductive drum 24 rotates in the direction of an arrow N.

The image forming station 22Y includes the primary transfer roller 30. The primary transfer roller 30 faces the photoconductive drum 24 with the intermediate transfer belt 21 therebetween. The image forming station 22Y charges the photoconductive drum 24 with the electrostatic charger 26 and then exposes selective portions of the photoconductive drum 24 with the exposure scanning head 27. The image forming station 22Y thus forms an electrostatic latent image on the photoconductive drum 24. The developing device 28 develops the electrostatic latent image on the photoconductive drum 24 by using a two-component developer that includes a toner and a carrier.

The primary transfer roller 30 transfers the toner image formed on the photoconductive drum 24 to the intermediate transfer belt 21. Collectively, the image forming stations 22Y, 22M, 22C, and 22K form a color toner image on the intermediate transfer belt 21 in this manner. The color toner image is formed by sequentially superimposing toner images of Y (yellow), M (magenta), C (cyan), and K (black).

The printer unit 18 includes a photoconductive cleaner 29. The photoconductive cleaner 29 has a cleaning blade that comes into contact with the photoconductive drum 24. The cleaning blade cleans the photoconductive drum 24 by removing residual toner (or other extraneous matter) from the photoconductive drum 24 after the primary transfer process.

The printer unit 18 includes a transfer unit 4. The transfer unit 4 includes backup roller 40 and a secondary transfer roller 32. The secondary transfer roller 32 faces the backup roller 40 with the intermediate transfer belt 21 therebetween. The secondary transfer roller 32 transfers the color toner image on the intermediate transfer belt 21 to a sheet S to form an image thereon.

The printer unit 18 includes a belt cleaner 43. The belt cleaner 43 faces the driven roller 41 with the intermediate transfer belt 21 therebetween. The belt cleaner 43 has a cleaning blade that comes into contact with the intermediate transfer belt 21. The cleaning blade cleans the intermediate transfer belt 21 by removing residual toner (or other extraneous matter) remaining on the intermediate transfer belt 21 after the secondary transfer.

The printer unit 18 includes a fixing unit 34. The fixing unit 34 applies heat and pressure to the sheet S to fix the toner image. In the MFP 10, the printer unit 18 forms a fixed toner image on the sheet S. The MFP 10 sends the sheet S after image fixing to a paper discharge unit 20. In the following description, the end of the sheet along the carry direction V1 toward the paper feeding unit 1 is referred to as “upstream side” and the end toward the paper discharge unit 20 side is referred to as the “downstream side.”

The MFP 10 includes a memory unit. For example, the memory unit is a random access memory (RAM). Various parameters and values can be recorded in the memory unit, for example, the number of accumulated printed sheets S and the position of sheets S in the paper feeding unit 1 are recorded.

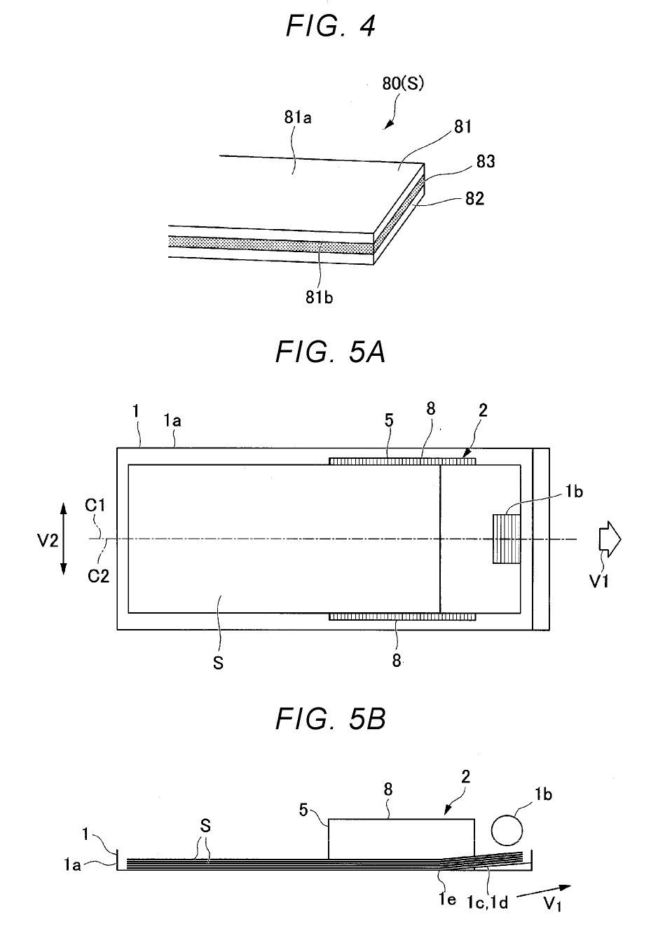

The sheet S may be a label sheet. FIG. 4 is a schematic view of an example of a label sheet. As shown in FIG. 4, a label sheet 80 includes base material 81, adhesive layer 83, and release paper 82. One surface (upper surface in FIG. 4) of the base material 81 is a printing surface 81a. The other surface of the base material 81 is an attachment surface 81b. The release paper 82 is affixed to the attachment surface 81b by the adhesive layer 83. The base material 81 is peelable from the release paper 82. The label sheet 80 can be rectangular. For example, the label sheet 80 can be a standard sheet size such as A4, B5, and the like.

Next, the operation of the moving mechanism 2 will be described.

The system control unit 100 (see FIG. 1) controls the operation of the moving mechanism 2 such that the positions of at least two sheets S carried in sequence from the paper feeding unit 1 to the transfer unit 4 are different in the width direction V2.

For example, in FIG. 2A, a center line C1 (centered in the width direction V2) of the sheet S coincides with a center line C2 (centered in the width direction V2) of the pickup roller 1b. The position of the sheet S in the width direction V2 is referred to as a reference position. As shown in FIG. 2B, the sheet S is at a sheet feeding position, which is a position at which the sheet S comes into contact with the pickup roller 1b. A sheet S (first sheet) is moved along the carrying direction V1 by the pickup roller 1b while the reference position of the sheet S is maintained.

As shown in FIG. 5A and FIG. 5B, the system control unit 100 controls the operation of the height adjusting mechanism 1c so that the sheet S can be moved from the sheet feeding position (contacting pickup roller 1b) to a retracted position, which is a position away from the pickup roller 1b. That is, the lifting and lowering mechanism lowers the lifting plate 1d, whereby the sheet S shifts to the retracted position. In this manner, when the position of the sheet S is adjusted in the width direction V2, the sheet S maybe smoothly moved away from the sheet feeding position to the retracted position by the height adjusting mechanism 1c.

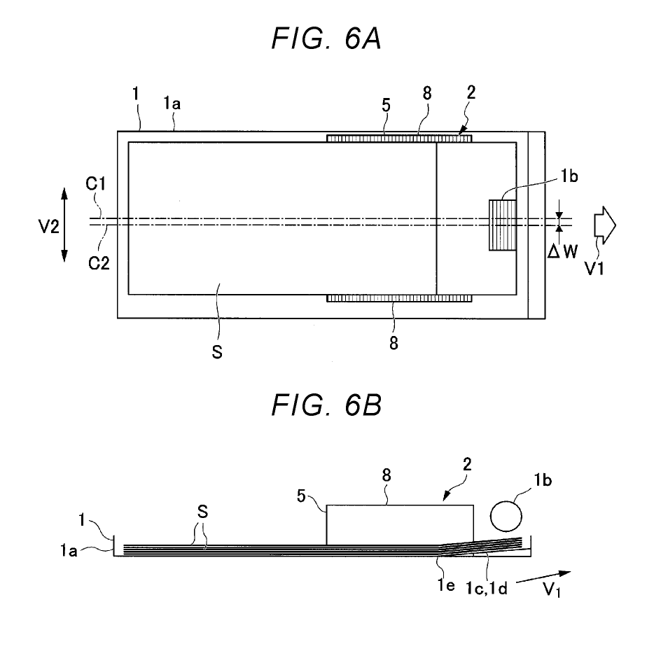

As shown in FIGS. 6A and 6B, the moving mechanism 2 can move the sheet S in the width direction V2. In FIG. 6A, the center line C1 of the sheet S is positioned at a position that is shifted from the center line C2 that corresponds to the center of the pickup roller 1b in the width direction V2. The sheet S is shifted by a moving distance AW in the width direction V2 from the reference position.

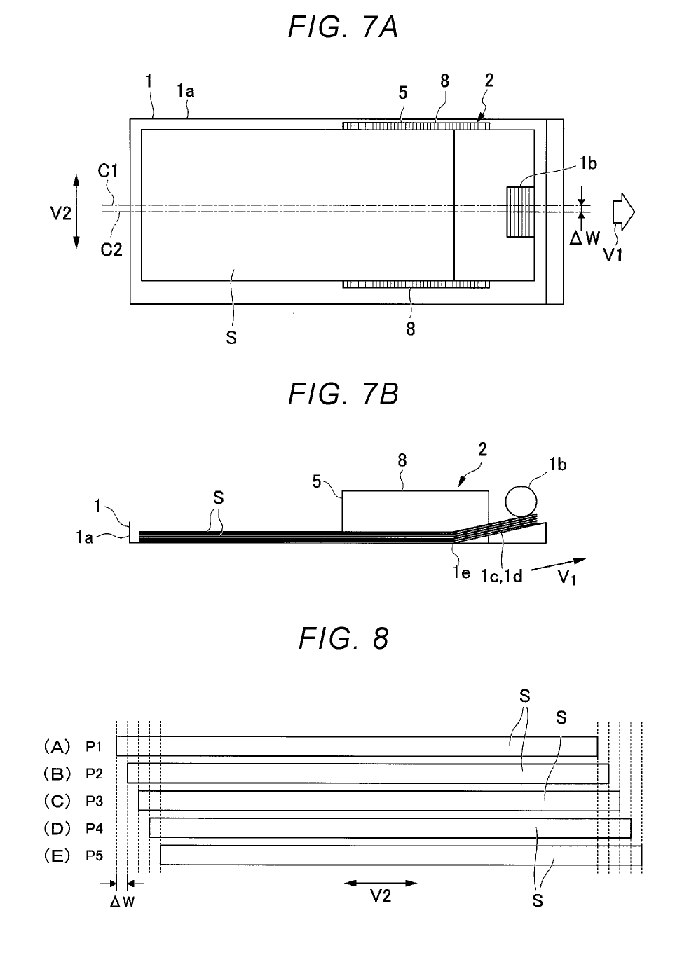

As shown in FIGS. 7A and 7B, when the lifting and lowering mechanism lifts the lifting plate 1d, the sheet S shifts to the paper feeding position. Another sheet S (second sheet) is sent along the carrying direction V1 by the pickup roller 1b after being shifted in the width direction V2. In this manner, it is possible to carry at least two sheets S to the carrying direction V1 in the MFP 10 while changing the positions of the sheets in the width direction V2.

The paper feeding unit 1 is provided with a sensor that detects the position of a sheet S in the width direction V2. This sensor detects the position of the sheet S in the width direction V2 and sends a detection signal to the system control unit 100. The detected position information of the sheet S is stored in a memory.

FIG. 8A to 8E are schematic views showing first to fifth positions P1 to P5 which are examples of possible arrangements or positions of the sheets S.

The first position P1 is a position closest to a first side (left side in FIG. 8) of the width direction V2. The second position P2 is shifted from the first position P1 towards a second side (to the right in FIG. 8) of the width direction V2. The third position P3 is shifted from the second position P2 towards the second side (to the right in FIG. 8) of the width direction V2. The fourth position P4 is shifted from the third position P3 towards the second side (to the right in FIG. 8) of the width direction V2. The fifth position P5 is shifted from the fourth position P4 towards the second side (to the right in FIG. 8) of the width direction V2.

In the MFP 10, in the paper feeding unit 1, the sheets S may be arranged in any one of the first to fifth positions P1 to P5 and carried along the carrying direction V1. For example, the MFP 10 may carry the sheets S to the carrying direction V1 while changing the position (in the width direction V2) every eight sheets by controlling the operation of the moving mechanism 2 with the system control unit 100.

For example, when number of accumulated printed sheets S is “n” (where, n is an integer of 1 or more), the value “n/8/5” that is calculated by dividing the number n of accumulated printed sheets by the number of sheets per arrangement (8 in this example) and also the number of possible arrangements (5 in this example, corresponding to number of positions (P1 to p5), will be 1.475, if the number n of accumulated printed sheets is 59. The number n of accumulated printed sheets S is equal to the number of accumulated sheets S printed by the printer unit 18. Printing on the sheet S can be detected by a sensor.

Note that a value k corresponding to the value after the decimal point in the value “n/8/5” (e.g., value k=0.475 for the above example value 1.475, is a numerical value greater or equal to 0 or more but less than 1. As shown in Table 1, if k is in the range of 0 to 0.2 (that is, 0≤k≤0.2), the first position P1 is selected as the position of the sheet S. If k is greater than 0.2 and less than or equal to 0.4 (that is, 0.2<k≤0.4), the second position P2 is selected. If k is greater than 0.4 and less than or equal to 0.6 (that is, 0.4<k0.6), the third position P3 is selected. If k is greater than 0.6 and less than or equal to 0.8 (that is, 0.6 <k≤0.8), the fourth position P4 is selected. If k is greater than 0.8 and less than 1 (that is, 0.8<k<1), the fifth position P5 is selected. This rule of arrangements for the sheets S is referred to as a first arrangement rule, and is summarized in Table 1.

TABLE 1

| | Sheet Position |
|---|---|
| 0 ≤ k ≤ 0.2 | P1 |
| 0.2 < k ≤ 0.4 | P2 |
| 0.4 < k ≤ 0.6 | P3 |
| 0.6 < k ≤ 0.8 | P4 |
| 0.8 < k ≤ 1 | P5 |

The order of arrangements of the sheet S in the width direction V2 is not particularly limited as long as the positions in the width direction V2 of at least two sheets S are different. For example, in the first arrangement rule described above, the arrangement of the sheets S is repeated from the first to fifth positions P1 to P5 in this order (ascending order), but the arrangement rule may be adopted such that ascending order and descending order are repeated. In this arrangement rule, the first to fifth positions P1 to P5 are selected in ascending order, and then the fifth to first positions P5 to P1 are selected in descending order. Thereafter, ascending order and descending order are alternated. The number of sheets S per arrangement is not limited to eight but may any number of one or more.

All the arrangements of the sheets S until the printing of a first sheet S is completed may be set to, for example, the first position P1.

As shown in FIG. 1, the system control unit 100 selects an exposure start timing or position of the exposure scanning head 27 according to the position of the sheet S in the width direction V2. As a result, the exposure scanning head 27 adjusts the position of the toner image on the intermediate transfer belt 21.

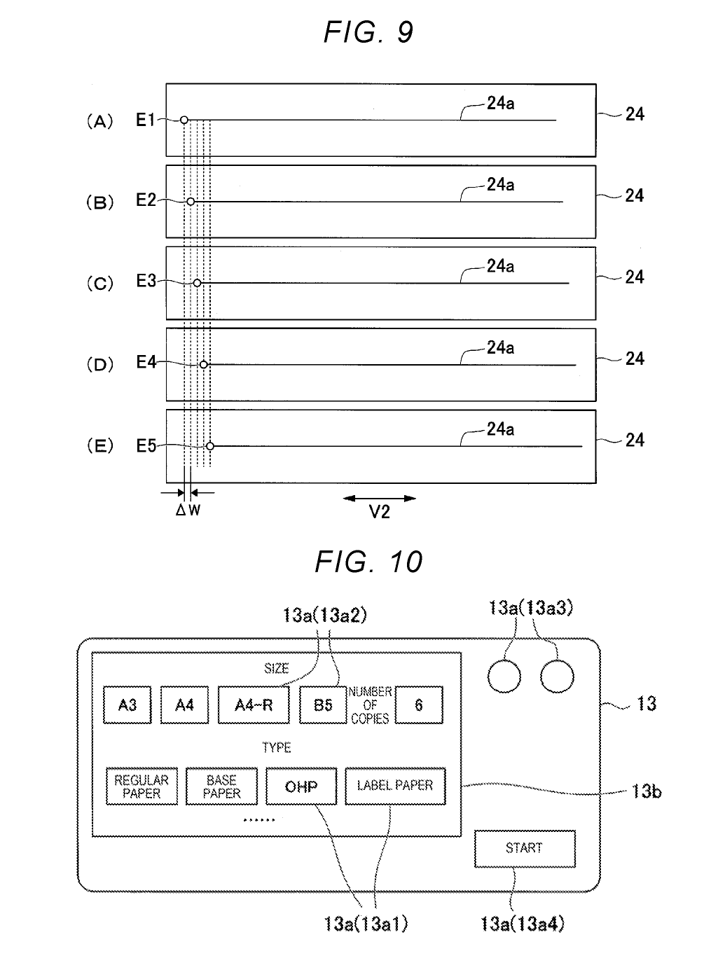

FIG. 9A to 9E are schematic views showing exposure starting points in the photoconductive drum 24 (see FIG. 1). The exposure scanning head 27 performs exposure based on image information along an exposure line 24a from the exposure start point. A first exposure start point E1 is closest to one side (the left side in FIG. 9) of the width direction V2. A second exposure start point E2 is at a position shifted from the first exposure start point E1 on the other side (to the right in FIG. 9) of the width direction V2. A third exposure start point E3 is at a position shifted from the second exposure start point E2 to the other side (to the right in FIG. 9) of the width direction V2. A fourth exposure start point E4 is at a position shifted from the third exposure start point E3 on the other side (to the right in FIG. 9) of the width direction V2. A fifth exposure start point E5 is at a position shifted from the fourth exposure start point E4 on the other side (to the right in FIG. 9) of the width direction V2.

For example, when the sheet S is at the first position P1 (see FIG. 8A), the first exposure start point E1 shown in FIG. 9A is selected as an exposure start point. When the sheet S is at the second to fifth positions P2 to P5 (see FIGS. 8B to 8E), the second to fifth exposure start points E2 to E5 shown in FIGS. 9B to 9E are selected. By selecting an exposure starting point, the position of the toner image on the intermediate transfer belt 21 becomes appropriate for the position of a sheet S. Therefore, it is possible to form an image at an appropriate position of the sheet S.

FIG. 10 is a schematic view showing an example of the control panel 13. The control panel 13 includes an input key 13a and a display portion 13b. The input key 13a receives an input by the user. For example, the control panel 13 is a touch panel in which the input key 13a and the display portion 13b are integrally formed. The control panel 13 outputs a command signal to the system control unit 100 in response to a user operation on the input key 13a.

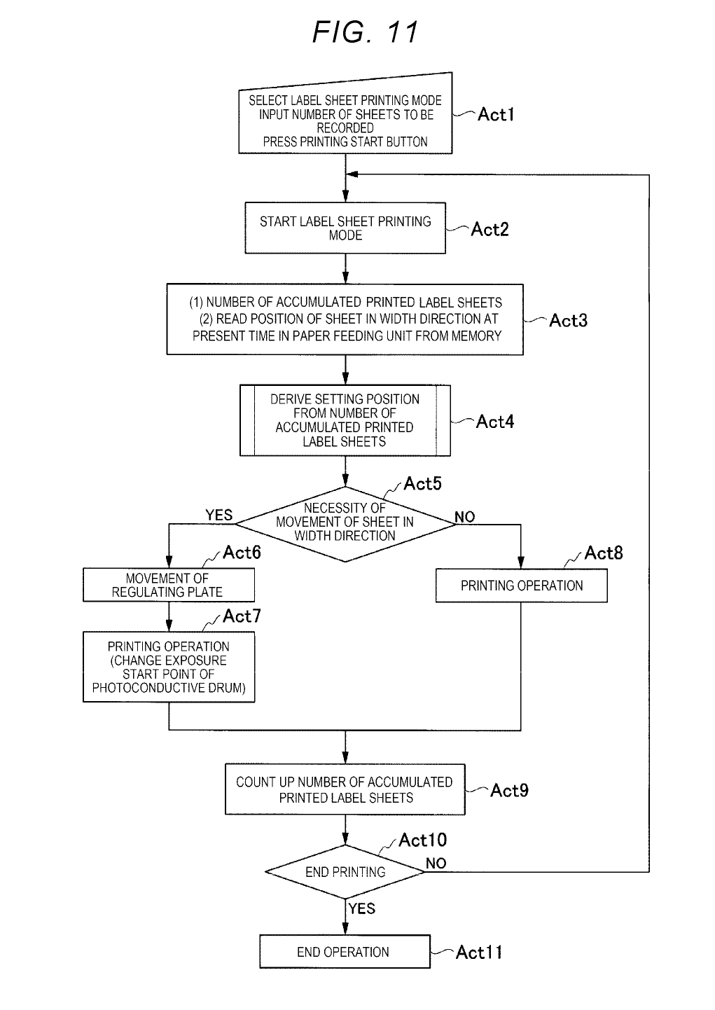

Next, an example of the operation of the MFP 10 will be described with reference to FIG. 11. For example, as shown in FIG. 1, the control of the moving mechanism 2 is in accordance with an instruction input by the user to the control panel 13. In addition, control of the moving mechanism 2 is performed based on scan data including sheet information such as paper size, print data, coordinate data, and the like.

As shown in FIG. 11, when a label sheet (label paper) is used, in the control panel 13 (see FIG. 10), the user selects a label sheet printing mode and sheet size with input keys 13a1 and 13a2. In the control panel 13 (see FIG. 10), the user inputs the number of necessary copies (the number of sheets to be output) with an input key 13a3. The user presses a printing start button (input key 13a4 in FIG. 10) (Act 1) to start the label sheet printing mode (Act 2).

The position of the label sheet in the width direction at the present time in the paper feeding unit 1 (see FIG. 2A) and the number of accumulated printed label sheets are read from the memory (Act 3). Next, for example, a preset position of a label sheet in the width direction of (hereinafter, referred to as setting position) is derived from the total number of printed label sheets according to the first arrangement rule described above (see Table 1) (Act 4).

From a comparison between a current position of the label sheet and the setting position, it can be determined whether it is necessary to move the label sheet in the width direction (Act 5). That is, if the current position of the label sheet in the width direction does not coincide with the setting position, it is determined that there is a necessity of movement of the label sheet in the width direction (Act 5: YES). Therefore, the moving mechanism 2 changes the position of the label sheet to coincide with the setting position (Act 6). The label sheet is then carried from the paper feeding unit 1 to the printer unit 18, and printing is performed (Act 7).

If the current position of the label sheet in the width direction coincides with the set position (Act 5: NO), instead of moving the regulating plate 8, the label sheet is carried from the paper feeding unit 1 to the printer unit 18 and printing is performed (Act 8).

Once a label sheet is printed, the printing completion is detected by a sensor. The total number of accumulated label sheets is tracked by the system control unit 100 (Act 9).

When the printing is ended (Act 10: YES), the operation of the MFP 10 is stopped (Act 11). When printing is to be continued (Act 10: NO), Act 2 and the subsequent acts are repeated.

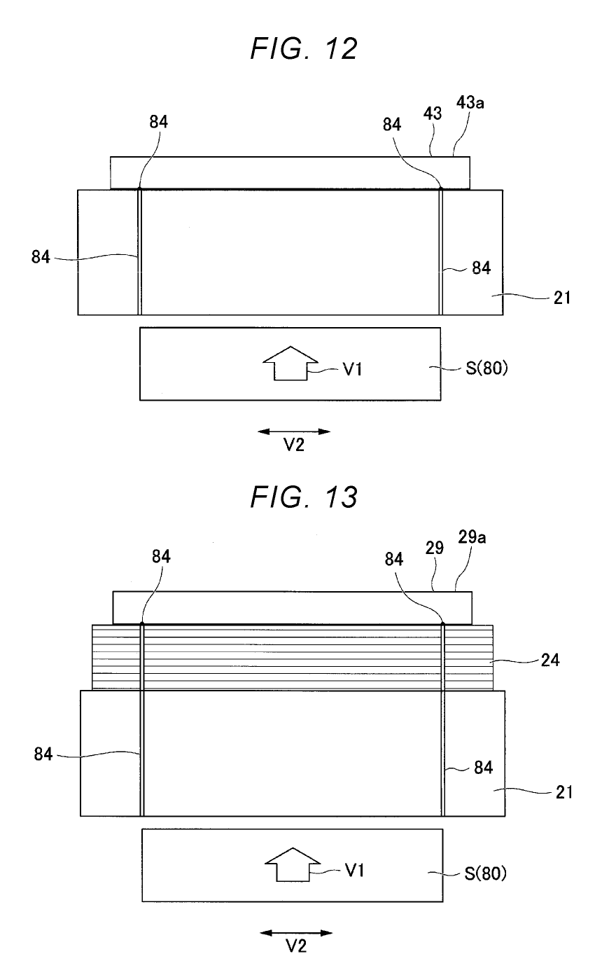

FIG. 12 show the intermediate transfer belt 21 (see also FIG. 1) and a cleaning blade 43a of the belt cleaner 43 (see also FIG. 1). As shown in FIG. 12, if the sheet S is a label sheet 80 (see FIG. 4), then the label sheet 80 comes into contact with the intermediate transfer belt 21, and an adhesive 84 protruding from the end portion of the label sheet 80 may adhere to the intermediate transfer belt 21 in some cases. It is difficult for the adhesive 84 to be completely removed by the cleaning blade 43a once it is attached to the intermediate transfer belt 21. If the adhesive 84 is deposited thickly on the intermediate transfer belt 21, there is a possibility that the cleaning blade 43a will not sufficiently come into contact with all portions of the intermediate transfer belt 21 due to this buildup of adhesive 84. In that case, toner might remain on the intermediate transfer belt 21 after a cleaning attempt. The residual toner might then adhere to the next label sheet 80 (or other sheet S) in the transfer unit 4, which may cause image contamination.

FIG. 13 is a configuration diagram showing the intermediate transfer belt 21), the photoconductive drum 24 (see also FIG. 1), and a cleaning blade 29a of the photoconductive cleaner 29 (see also FIG. 1). As shown in FIG. 13, if the sheet S is the label sheet 80, the adhesive 84 attached to the intermediate transfer belt 21 may adhere to the photoconductive drum 24. It is difficult for any adhesive 84 attached to the photoconductive drum 24 to be completely removed by the cleaning blade 29a. If the adhesive 84 is deposited thickly on the photoconductive drum 24, there is a possibility that the cleaning blade 29a will not sufficiently come into contact with all portions of the photoconductive drum 24 due to this buildup of adhesive 84. In that case, part of the toner remains on the photoconductive drum 24 without being removed, and then this remaining toner adheres to the next label sheet 80 (or sheet S) to be printed, which may cause image contamination.

As described above, since the MFP 10 according to the present embodiment includes a moving mechanism 2 that moves sheets S in the width direction V2, it is possible to carry at least two sheets S in the carrying direction V1 while changing the positions of these two sheets S in the width direction V2. Therefore, even when the adhesive protrudes from a label sheet, it is possible to avoid the buildup of the adhesive 84 at a specific portion of the intermediate transfer belt 21 and/or the photoconductive drum 24. Therefore, troubles are less likely to occur in removing the toner with the cleaning blade (s). Therefore, it is possible to suppress image contamination caused by residual toner left on the intermediate transfer belt 21.

The moving mechanism 2 moves a sheet S that is in a stationary state (that is while it is held by the paper feeding unit 1) in the width direction V2. Therefore, compared with the case of adjusting the position of sheets S while they are being carried along carrying direction within the MFP 10, it is possible to position the sheets S with higher accuracy in the width direction V2.

As shown in FIG. 9, the MFP 10 may optimize the position of the toner image on the intermediate transfer belt 21 by selecting an exposure starting point. Therefore, it is possible to form an image at an appropriate position in the width direction V2 according to the position of the sheet S being printed.

The height adjusting mechanism 1c shifts the sheet S from the sheet feeding position to the retracted position when the sheet S is to be moved in the width direction V2 by moving mechanism 2. Therefore, it is possible to perform the lateral positioning of the sheet S smoothly.

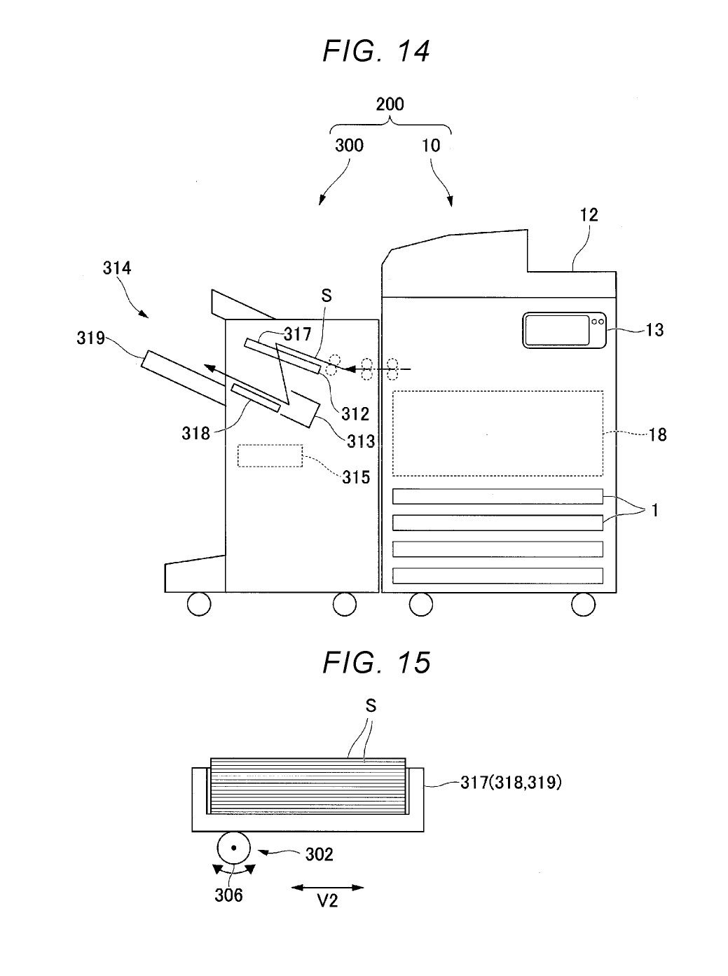

FIG. 14 is a configuration view of an image forming system 200 which is an image forming system of an embodiment. As shown in FIG. 14, the image forming system 200 includes a MFP 10 and a post-processing apparatus 300 shown in FIG. 1. The post-processing apparatus 300 performs post-processing on the sheets S from the MFP 10. For example, post-processing in this context is stapling, punching, folding, sorting, binding, and the like.

The post-processing apparatus 300 includes a standby unit 312, a processing unit 313, a discharge unit 314, a post-processing control unit 315, and a displacement mechanism 302 (see also FIG. 15) . The standby unit 312 temporarily holds, that is, buffers, a sheet S or sheets S carried from the MFP 10. The standby unit 312 includes a standby tray 317 which receives the sheets S. The processing unit 313 performs post-processing on sheets S. The processing unit 313 includes a processing tray 318 that receives sheets S. For example, the processing unit 313 performs stapling on a sheet bundle include several sheets S as a post-processing step. The processing unit 313 discharges the post-processed sheets S to the discharge unit 314. The discharge unit 314 includes a movable receiving tray 319 that receives these sheets S.

FIG. 15 is a configuration view of the displacement mechanism 302. As shown in FIG. 15, the displacement mechanism 302 includes a driving gear 306 and a driving source, which maybe a motor or the like. Teeth or gearing to mesh with teeth on the driving gear 306 are on the trays 317, 318, and 319. The driving gear 306 is rotationally driven by the driving source so as to move the trays 317, 318, and 319 in the width direction V2.

The post-processing control unit 315 controls the operation of the displacement mechanism 302. The post-processing control unit 315 adjusts the positions of the trays 317, 318, 319 in the width direction V2 by using the displacement mechanism 302. The positions for trays 317, 318, 319 can be based on a signal from the system control unit 100 of the MFP 10. Accordingly, it is possible to select the positions of the trays 317, 318, and 319 in accordance with the particular position (in the width direction V2) of the sheets S being carried from the MFP 10.

An example of a modification of the above described embodiments will be described.

The moving mechanism 2, as depicted in FIG. 3, moves sheets S in the paper feeding unit 1, but the position of moving mechanism 2 is not limited to the paper feeding unit 1. A moving mechanism 2 or the like may be provided at other positions upstream (along the carrying direction V1) of the transfer unit 4. For example, a moving mechanism 2 may be provided in conjunction with in any of the carrying roller 33a, the alignment roller 33b, and the carrying guide 33c of the carrying unit 3. In this case, the moving mechanism 2 may adjust the position (in the width direction V2) of the sheets S being carried by the carrying unit 3.

The MFP 10 depicted in FIG. 1 includes a belt cleaner 43 that cleans the intermediate transfer belt 21 and the photoconductive cleaner 29 that cleans the photoconductive drum 24, but the MFP 10 might include only belt cleaner 43 or photoconductive cleaner 29.

As shown in FIG. 8, the MFP 10 may arrange the sheets S at any of the five positions P1 to P5, but the number of possible positions can be any number greater than or equal to two.

The moving direction of the sheet S by the moving mechanism 2 shown in FIG. 2A is the width direction V2, but the moving direction of the sheet is not limited to this direction. The moving direction of the sheet may be any direction as long as the direction intersects with the carrying direction V1 of the sheet. For example, the moving direction of the sheet may be a direction parallel to one surface of the sheet S and inclined at an angle θ1 (0°<θ1<90°) with respect to the carrying direction V1.

The moving directions of the trays 317, 318, and 319 by the displacement mechanism 302 shown in FIG. 15 are not limited to the width direction V2. The moving direction of the tray may be any direction as long as the tray intersects with the carrying direction of the sheet. For example, the moving direction of the tray may be a direction parallel to one surface of the sheet S and inclined at an angle θ2 (0°<θ2<90°) with respect to the carrying direction V1.

In the MFP 10, the system control unit 100 controls the operation of the moving mechanism 2, but the moving mechanism 2 may be configured to move the sheet S in the width direction V2 without control. For example, the moving mechanism 2 may include a cam mechanism and a driving source that operate autonomously of the system control unit 100. Such a moving mechanism 2 operates the positioning member by operation of the cam mechanism. An image forming apparatus of an embodiment may be, or include, an ink jet type image forming apparatus rather than a toner based system.

An image forming apparatus of the embodiment may directly transfer the toner image from the photoconductive drum to the sheet rather than by use of a transfer belt or the like.

According to various embodiments described above, it is possible to carry at least two sheets at two different respective positions in the width direction. Therefore, even when adhesive protrudes from a label sheet, it is possible to avoid the concentration or buildup of the adhesive at specific positions of an intermediate transfer member and the like. Therefore, printing errors and image degradations are less likely due to failures in removing toner with the cleaning blade (s). Therefore, it is possible to reduce the image contamination issues caused by residual toner on the intermediate transfer member.

While certain embodiments have been described, these embodiments have been presented by way of example only, and are not intended to limit the scope of the present disclosure. Indeed, the novel embodiments described herein may be embodied in a variety of other forms; furthermore, various omissions, substitutions and changes in the form of the embodiments described herein may be made without departing from the spirit of the present disclosure. The accompanying claims and their equivalents are intended to cover such forms or modifications as would fall within the scope and spirit of the present disclosure.

What is claimed is:

1. An image forming apparatus, comprising:
a sheet feeding unit configured to hold a plurality of sheets;
an image forming unit configured to form a toner image on a sheet;
a carrying unit configured to sequentially carry sheets from the sheet feeding unit in a carrying direction towards the image forming unit;
a mechanical cleaner to remove extraneous matter from a portion of the image forming unit; and
a moving mechanism configured to re-position the sheet along a width direction intersecting the carrying direction, the moving mechanism being on an upstream side of a position along the carrying direction at which the toner image is formed on the sheet.

2. The image forming apparatus according to claim 1, wherein the image forming unit includes:
a photoconductive drum on which the toner image is initially formed;
an intermediate transfer member to which the toner image formed on the photoconductive drum is transferred; and
a transfer unit configured to transfer the toner image from the intermediate transfer member to the sheet.

3. The image forming apparatus according to claim 2, wherein mechanical cleaner is a blade contacting the photoconductive drum.

4. The image forming apparatus according to claim 2, wherein the mechanical cleaner is a blade contacting the intermediate transfer member.

5. The image forming apparatus according to claim 1, wherein the image forming unit is a color printer.

6. The image forming apparatus according to claim 1, wherein the moving mechanism is configured to re-position the sheet along the width direction while the sheet is in the sheet feeding unit.

7. The image forming apparatus according to claim 6, wherein the moving mechanism comprises a driving gear engaging a portion of the sheet feeding unit.

8. The image forming apparatus according to claim 1, wherein
the image forming unit includes:
a photoconductive member,
a charger configured to charge a surface of the photoconductive member,
an exposure unit configured to expose the photoconductive member to form an electrostatic latent image thereon, and
a developer configured to develop the electrostatic latent image to form the toner image on the photoconductive member; and
a system controller is configured to adjust an exposure start point on the photoconductive member to correspond to positioning of sheets along the width direction.

9. The image forming apparatus according to claim 1, wherein
the sheet feeding unit includes:
a sheet storage tray on which the plurality of sheets are stacked,
a pickup roller configured to come into contact a top sheet on the storage tray and carry the top sheet along the carrying direction, and
a height adjusting mechanism configured to change a position of the plurality of sheets on the sheet storage tray relative to a position of the pickup roller such that the pickup roller contacts the top sheet or not; and
a system controller is configured to control the height adjusting mechanism such that pickup roller is not in contact with the top sheet when the moving mechanism is re-positioning a sheet along the width direction.

10. The image forming apparatus according to claim 1, further comprising:
a post-processing apparatus that performs post-processing on sheets passed through the image forming unit, wherein the post-processing apparatus includes:
a sheet receiving tray on which sheets can be stacked, and
a displacement mechanism configured to move the sheet receiving tray in a direction intersecting with the carrying direction.

11. An image forming apparatus, comprising:
a sheet feeding unit configured to hold a plurality of sheets;
a carrying unit configured to sequentially carry sheets from the sheet feeding unit in a carrying direction;
an image forming unit configured to form a toner image;
an intermediate transfer member to which the toner image is transferred;
a transfer unit configured to transfer the toner image on the intermediate transfer member onto a sheet carried by the carrying unit;
a first mechanical cleaner that comes into contact with one of the intermediate transfer member and the image forming unit to remove extraneous matter; and
a moving mechanism configured to re-position the sheet along a width direction intersecting the carrying direction, the moving mechanism being on an upstream side along the carrying direction of the transfer unit.

12. The image forming apparatus according to claim 11, wherein the moving mechanism is coupled to the sheet feeding unit and configured to move the sheet feeding unit along the width direction to re-position the sheet.

13. The image forming apparatus according to claim 11, wherein the sheet feeding unit includes:
a sheet storage tray on which the plurality of sheets are stacked;
a pickup roller configured to come into contact a top sheet on the storage tray and carry the top sheet along the carrying direction; and
a height adjusting mechanism configured to a change position of the plurality of sheets on the sheet storage tray relative to a position of the pickup roller such that the pickup roller contacts the top sheet or not.

14. The image forming apparatus according to claim 13, further comprising:
a system controller that is configured to control the height adjusting mechanism such that pickup roller is not in contact with the top sheet when the moving mechanism is re-positioning the sheet along the width direction.

15. The image forming apparatus according to claim 11, further comprising:
a second mechanical cleaner that comes into contact with one of the intermediate transfer member and the image forming unit to remove extraneous matter.

16. The image forming apparatus according to claim 11, wherein
the image forming unit includes:
a photoconductive member,
a charger configured to charge a surface of the photoconductive member,
an exposure unit configured to expose the photoconductive member to form an electrostatic latent image thereon, and
a developer configured to develop the electrostatic latent image to form the toner image on the photoconductive member; and
a system controller is configured to adjust an exposure start point on the photoconductive member to correspond to positioning of sheets along the width direction.

17. The image forming apparatus according to claim 11, further comprising:
a post-processing apparatus that performs post-processing on sheets passed through the image forming unit, wherein the post-processing apparatus includes:
a sheet receiving tray on which sheets can be stacked, and
a displacement mechanism configured to move the sheet receiving tray in a direction intersecting with the carrying direction.

18. A multi-functional peripheral device, comprising:
a sheet feeding unit configured to hold a plurality of sheets;
a printer unit configured to forma toner image on a sheet from the sheet feeding unit in a printing process;
a carrying unit configured to sequentially carry sheets from the sheet feeding unit in a carrying direction of the printer unit;
a mechanical cleaner to remove extraneous matter from a portion of the printer unit during the printing process; and
a moving mechanism configured to re-position the sheet along a width direction intersecting the carrying direction, the moving mechanism being on an upstream side of a position along the carrying direction at which the toner image is formed on the sheet in the printing process.

19. The multi-functional peripheral device according to claim 18, wherein
the printing unit includes:
a photoconductive member,
a charger configured to charge a surface of the photoconductive member,
an exposure unit configured to expose the photoconductive member to form an electrostatic latent image thereon, and
a developer configured to develop the electrostatic latent image to form the toner image on the photoconductive member; and
a system controller is configured to adjust an exposure start point on the photoconductive member to correspond to positioning of sheets along the width direction.

20. The multi-functional peripheral device according to claim 18, wherein
the sheet feeding unit includes:
a sheet storage tray on which the plurality of sheets are stacked,
a pickup roller configured to come into contact a top sheet on the storage tray and carry the top sheet along the carrying direction, and
a height adjusting mechanism configured to change a position of the plurality of sheets on the sheet storage tray relative to a position of the pickup roller such that the pickup roller contacts the top sheet or not; and
a system controller is configured to control the height adjusting mechanism such that pickup roller is not in contact with the top sheet when the moving mechanism is re-positioning a sheet along the width direction.
